(19) United States
(12) Patent Application Publication
(10) Pub. No.: US 2003/0192654 A1
(43) Pub. Date: Oct. 16, 2003

(54) Lift coard concealable venetian blind

(75) Inventor: Ming Nien, Changhua Hsien (TW)

Correspondence Address: BACON & THOMAS, PLLC, 625 SLATERS LANE, FOURTH FLOOR, ALEXANDRIA, VA, 22314

(73) Assignee: Nien Made Enterprise Co., Ltd.

(21) Appl. No.: 10/170,537

(22) Filed: Jun. 14, 2002

(30) Foreign Application Priority Data
Apr. 11, 2002 (TW) 91204733

(51) Int. Cl. E06B 9/30

(52) U.S. Cl. 160/168.1 R

(57) ABSTRACT

A lift cord concealable Venetian blind lift is constructed to include a retractable tube formed of a plurality of tube bodies that slide one inside another and fastened to one end of each lift cord and moved between a received position and an extended position to control the elevation of the bottom rail. Each lift cord of the Venetian blind has one end fixedly fastened to the bottom rail, and the other end longitudinally extended through the headrail and then downwardly extended out of one end of the headrail into the inside of the retractable tube and coupled to the last tube body of the retractable tube for moving with the last tube body of the retractable tube to control the elevation of the bottom rail.

### BACKGROUND OF THE INVENTION

1. Field of the Invention

The present invention relates to Venetian blinds and, more specifically, to a lift cord concealable Venetian blind that keeps the lift cords from sight and from reach of children.

2. Description of the Related Art

A regular Venetian blind is generally comprised of a top rail, a bottom rail, a plurality of slats arranged in parallel between the top rail and the bottom rail, a lift control mechanism for controlling lifting and positioning of the bottom rail to adjust the extending area of the Venetian blind, and a tilting control mechanism for controlling the tiling angle of the slats to regulate the light. The lift control mechanism comprises a lift cord suspended from the top rail at one side for operation by hand to control the elevation of the bottom rail. Because the lift cord is exposed to the outside, it destroys the sense of beauty of the Venetian blind. Further, because a child can easily reach the exposed lift cord, an accident may occur when a child pulling the lift cord for fun. In order to eliminate this problem, Venetian blinds with receivable lift cord(s) are developed. Exemplars of these Venetian blinds are seen in U.S. Pat. Nos. 2,382,100; 5,531,257; 3,014,124. However, these Venetian blinds are commonly have a complicated structure and high manufacturing cost.

### SUMMARY OF THE INVENTION

It is the main object of the present invention to provide a lift cord concealable Venetian blind, which keeps the lift cords from sight and out of reach of children.

It is another object of the present invention to provide a lift cord concealable Venetian blind, which is easy to operation.

It is still another object of the present invention to provide a lift cord concealable Venetian blind, which has a simple structure and, is inexpensive to manufacture.

To achieve these objects of the present invention, the lift cord concealable Venetian blind comprises a headrail extended in transverse direction, the headrail having a first end; a bottom rail extended in transverse direction and spaced below the headrail; a plurality of slats arranged in parallel between the headrail and the bottom rail; at least one lift cord, each lift cord having a first end fixedly fastened to the bottom rail and a second end upwardly extended through a respective through hole in each slat into the inside of the headrail and then transversely extended to the first end of the headrail and then extended vertically downwards from the first end of the headrail; and a vertically downwardly extended retractable tube fastened to the second end of each lift cord and moved between a received position and an extended position to control the elevation of the bottom rail. The retractable tube comprises a plurality of tube bodies that slide one inside another. The tube bodies of the retractable tube include at least a vertically downwardly extended first tube body and a last tube body. The second end of each lift cord is respectively downwardly extended out of the first end of the headrail and inserted into the inside of the retractable tube and coupled to the last tube body of the retractable tube for moving with the last tube body of the retractable tube to control the elevation of the bottom rail.

### BRIEF DESCRIPTION OF THE DRAWINGS

FIG. 1 is a schematic drawing of a first embodiment of the present invention, showing the lift cord concealable Venetian blind extended out.

FIG. 2 is a schematic drawing showing the locking position of the lift cord for the lift cord concealable Venetian blind according to the first embodiment of the present invention.

FIG. 3 is a schematic drawing corresponding to FIG. 3, showing the lift lock unlocked.

FIG. 4 is a schematic drawing corresponding to FIG. 1, showing a received status of the Venetian blind.

FIG. 5 is a schematic drawing showing the retractable tube of the lift cord concealable Venetian blind received according to the first embodiment of the present invention.

FIG. 6 is a schematic drawing of a second embodiment of the present invention, showing the lift cord concealable Venetian blind extended out.

FIG. 7 is a schematic drawing corresponding to FIG. 6, showing a received status of the Venetian blind.

FIG. 8 is a schematic drawing showing the lift cords extended over the cord detour guide and turned upwards in the last tube body of the retractable tube according to the second embodiment of the present invention.

FIG. 9 is a schematic drawing of a third embodiment of the present invention, showing the lift cord concealable Venetian blind extended out.

FIG. 10 is a schematic drawing corresponding to FIG. 9, showing a received status of the Venetian blind.

### DETAILED DESCRIPTION OF THE PREFERRED EMBODIMENT

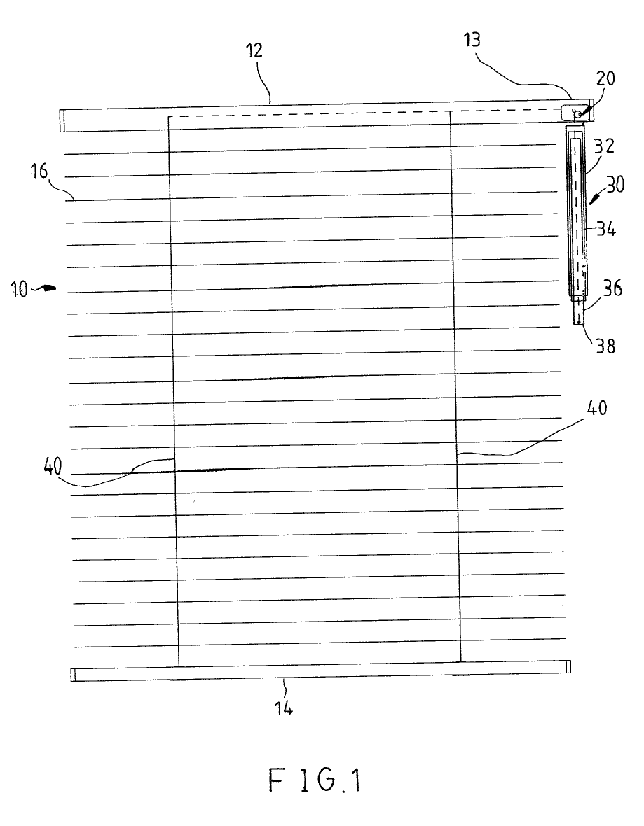

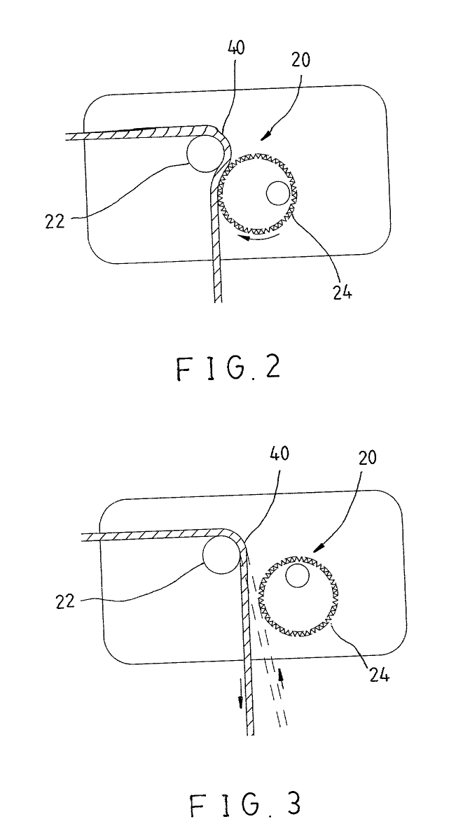

Referring to FIG. 1, a lift cord concealable Venetian blind 10 is shown comprising a headrail 12 fixedly transversely fastened to the top side of the window, the headrail 12 having a first end 13 (the right end), a bottom rail 14 extended in transverse direction and spaced below the headrail 12, a number of slats 16 arranged in parallel between the headrail 12 and the bottom rail 14, a lift lock 20 installed in the first end 13 of the headrail 12, the lift lock 20, as shown in FIGS. 2 and 3, comprised of a transverse guide rod 22 and an eccentric ratchet wheel 24; a retractable tube 30 suspended from the first end 13 of the headrail 12 at one side, and two lift cords 40.

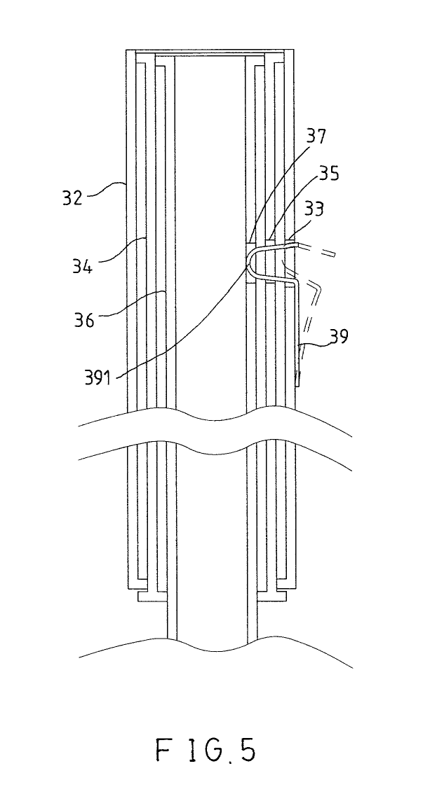

The retractable tube 30 is comprised of a first tube body 32, a second tube body 34, and a third tube body (last tube body) 36. The tube bodies 32;34;36 slide one inside another. The first tube body 32 has one end, namely, the top end pivoted to (or hung on) the bottom side of the first end 13 of the headrail 12 for swinging within a limited angle. The second tube body 34 has an outer diameter slightly smaller than the inner diameter of the first tube body 32, and is axially slidably inserted into the first tube body 32. The second tube body 34 can be moved axially relative to the first tube body 32 between the extended position where the second tube body 34 is extended out of the first tube body 32 (with the top end of the second tube body 34 maintained inside the first tube body 32), and the received position where the second tube body 34 is received in the first tube body 32 (with the bottom end of the second tube body 34 disposed outside the first tube body 32). The third tube body 36 has an outer diameter slightly smaller than the inner diameter of the second tube body 34, and is axially slidably inserted into the second tube body 34.The third tube body 36 can be moved axially relative to the second tube body 34 between the extended position where the third tube body 36 is extended out of the second tube body 34 (with the top end of the third tube body 36 maintained inside the second tube body 34), and the received position where the third tube body 36 is received in the second tube body 34 (with the bottom end of the third tube body 36 disposed outside the second tube body 34). The bottom end of the third tube body 36 is provided with a handgrip 38 disposed outside the second tube body 34 for the holding of the hand. As illustrated in FIG. 5, the tube bodies 32;34;36 each have a respective retaining hole 33;35;37 transversely disposed near the respective top end. The first tube body 32 is peripherally fixedly mounted with a retaining spring plate 39. The retaining spring plate 39 has a protruded retaining portion 391 formed in the free end thereof and engaged into retaining hole 33. When the retractable tube 30 received, the protruded retaining portion 391 engage the retaining holes 33;35;37 of the tube bodies 32;34;36, holding the tube bodies 32;34;36 one inside another, i.e., holding the retractable tube 30 in the received condition. When the user pulls the handgrip 38 downwards, the protruded retaining portion 391 is forced outwards to disengage the tube bodies 32;34;36, for enabling the retractable tube 30 to be extended out.

The lift cords 40 have a respective first end symmetrically fixedly fastened to the bottom rail 14, and a respective top end upwardly inserted through a respective through hole (not shown) in each slat 16 and then inserted into the inside of the headrail 12 and then extended in the same direction toward the first end 13 of the headrail 12 and then extended over the transverse guide rod 22 of the lift lock 20 and then turned downwards through the gap between the transverse guide rod 22 and the eccentric ratchet wheel 24 into the inside of the tube bodies 32;34;36 of the retractable tube 30 and at final fixedly fastened to the inside of the third tube body 36 near the handgrip 38 (alternatively, one single lift cord may be used and inserted through a first through hole in each slat and the bottom rail and then inserted through a second through hole in the bottom rail and each slat and then extended through the headrail and the retractable tube and then fixedly fastened with the ends to the handgrip of the third tube body of the retractable tube; subject to the size of the Venetian blind, three lift cords may be used).

The Venetian blind 10 further comprises a tilting control mechanism adapted for controlling the tilting angle of the slats. Because the tilting control mechanism is of the known art and not within the scope of the claims of the present invention, no further detailed description in this regard is necessary.

When the lift cords 40 of the Venetian blind receive no external force, the lift lock 20 locks the lift cords 40 (see FIG. 2). The gravity weight of the bottom rail 14 and the slats 16 pulls the lift cords 40 downwards (i.e., the lift cords 40 are pulled leftwards in the headrail 12), thereby causing the eccentric ratchet wheel 24 to be rotated clockwise by the lift cords 40. When the eccentric ratchet wheel 24 rotated clockwise, it forces the lift cords 40 against the periphery of the guide rods 22, thereby causing the lift cords 40 to be jammed in between the eccentric ratchet wheel 24 and the guide rod 22 to hold the bottom rail 14 at a particular elevation.

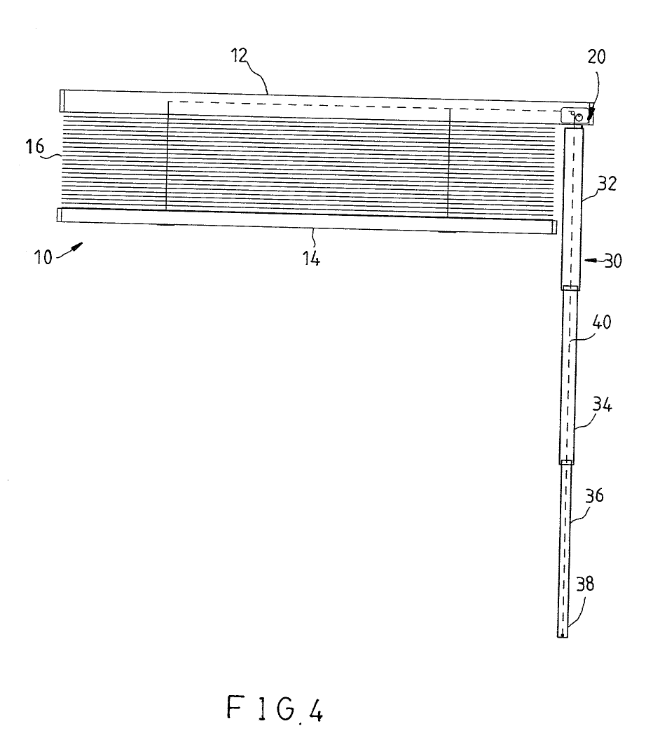

Because the lift cords 40 have a fixed length, the last tube body (the third tube body 36) of the retractable tube 30 is disposed at a relatively higher elevation when the bottom rail 14 disposed at a relatively lower elevation (see FIGS. 1 and 4). On the contrary, when the bottom rail 14 disposed at a relatively higher elevation, the third tube body 36 is disposed at a relatively lower elevation. Therefore, when the Venetian blind 10 fully extended out, the bottom rail 14 is disposed in the lowest position, and the tube bodies 32;34;36 are completely received one inside another, i.e., the second tube body 34 is received inside the first tube body 32, the third tube body 36 is received inside the second tube body 34, and the handgrip 38 is maintained exposed to the outside. When the Venetian blind 10 fully received, the bottom rail 14 is disposed in the topmost position, the tube bodies 32;34;36 are completely extended one outside another, i.e., the second tube body 34 is extended out of the first tube body 32, the third tube body 36 is extended out of the second tube body 34, and the handgrip 38 is disposed slightly lower than the elevation of the stool of he window.

When changing the extended area of the Venetian blind 10, hold the handgrip 38 with the hand and then move it to stretch the retractable tube 30 and the lift cords 40 rightwards, thereby causing the lift cords 40 to move the eccentric ratchet wheel 24 in one direction and to expand the gap between the eccentric ratchet wheel 24 and the guide rod 22 for enabling the lift cords 40 to be moved relative to the lift cord 20. At this time, the user can pull the handgrip 38 to extend out the third tube body 36 of the retractable tube 30 and to further lift the bottom rail 14. On the contrary, when the user reduce the pulling force at this time, the bottom rail 14 and the slats 16 are lowered automatically due to the effect of the respective gravity weight and, at the same time the lift cords 40 pull the third tube body 36 upwards into the inside of the second tube body 34. When the user released the hand from the handgrip 38 after the bottom rail 14 has been adjusted to the desired elevation, the retractable tube 30 is returned to the vertical position, and the lift lock 20 locks the lift cords 40 again.

As indicated above, the user can control the lifting and positioning of the Venetian blind 10 easily (same as the operation of conventional Venetian blinds). Further, because the outer ends of the lift cords 40 that extend out of the first end 13 of the headrail 12 are received inside the tube bodies 32;34;36 of the retractable tube 30, the lift cords 40 are kept out of reach of children and prohibited from hooking on the arm or the neck accidentally.

In the aforesaid embodiment, the retractable tube 30 is comprised of three tube bodies 32;34;36 that slide one inside another. Alternatively, the retractable tube 30 can be made having two, four, five, or more than five tube bodies that slide one inside another. Further, in the aforesaid embodiment, the lower tube body is axially slidably inserted into the upper tube body. Alternatively, the retractable tube can be made with the lower tube body axially slidably sleeved onto the upper tube body.

The aforesaid lift lock may be eliminated. Correspondingly, the tube bodies of the retractable tube are so arranged that the retractable tube can be moved between the extended position and the received position and positioned at any elevation between the extended position and the received position, i.e., the friction resistance between each two tube bodies of the retractable tube is sufficient to bear the gravity weight of the bottom rail and the slats of the Venetian blind when the lift cords receive no external force.

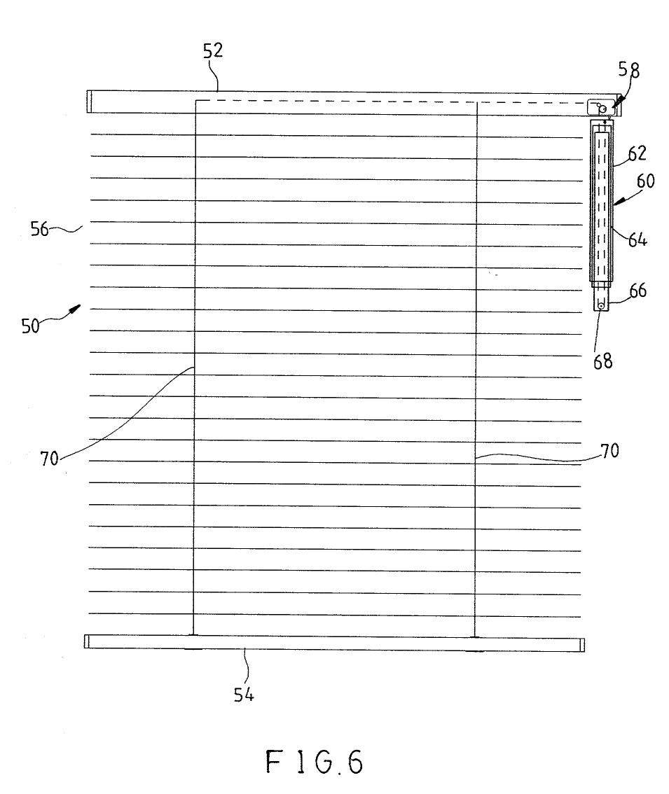

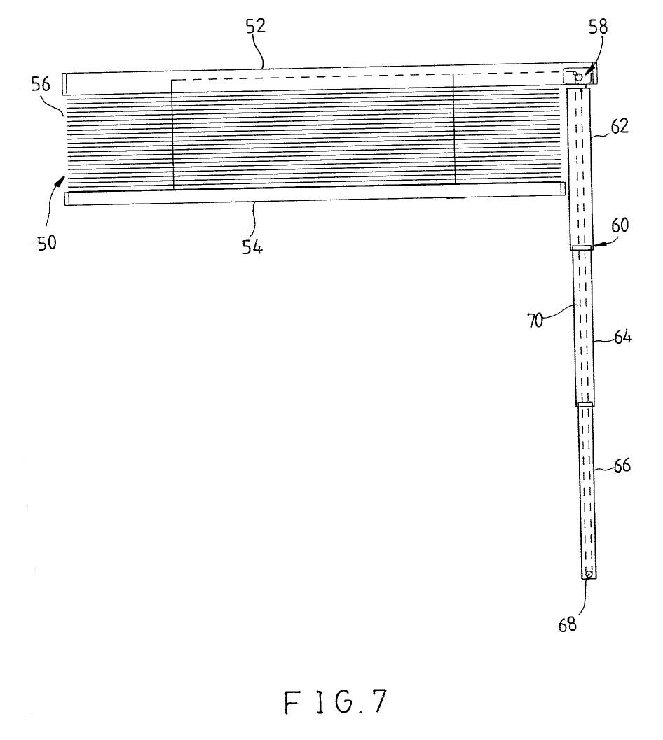

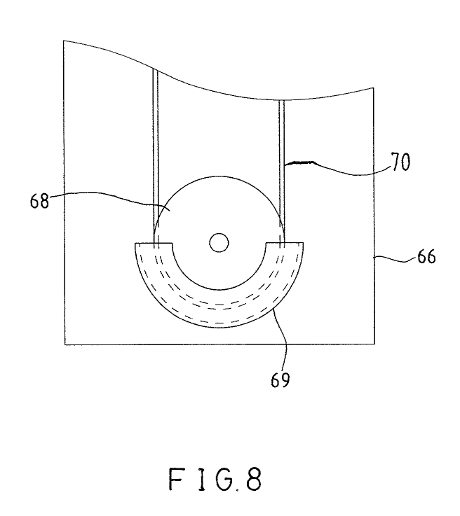

FIGS. 6-8 show a lift cord concealable Venetian blind according to a second embodiment of the present invention. According to this embodiment, the lift cord concealable Venetian blind 50 is comprised of a headrail 52, a bottom rail 54, a set of slats 56, a lift lock 58, a retractable tube 60, and two lift cords 70. The main features of this second embodiment are outlined hereinafter. The last tube body 66 of the retractable tube 60 comprises a cord detour guide 68 provided near the bottom end thereof and adapted for guiding the lift cords 70 backwards. According to this embodiment, the cord detour guide 68 is a pulley pivoted to the inside of the last tube body 66. Further, a smoothly arched guard 69 is provided at the bottom end of the last tube body 66 and spaced around the periphery of the pulley 68. The lift cords 70 are extended out of one end of the headrail 52 into the inside of the retractable tube 60, and then extended over the pulley 68, and then turned upwards and fixedly connected to the inside of the first tube body 62 of the retractable tube 60. The smoothly arched guard 69 guides the lift cords 70 over the pulley 68 and stops the lift cords 70 from escaping out of the pulley 68. When the lift cords 70 released from the constraint of the lift lock 58, the user can then extend out the retractable tube 60 to stretch the lift cords 70 and to further lift the bottom rail 54 to the desired elevation. When the hand released from the retractable tube 60 after disengagement of the lift cords 70 from the lift lock 58, the bottom rail 54 and the slats 56 are lowered due to the effect of the respective gravity weight, thereby causing the last tube body 66 to be moved upwards to receive the retractable tube 60. Because the lift cords 70 go round in the retractable tube 60, the amount of elevational variation of the bottom rail 54 is 2n when the amount of variation of the length of the retractable tube 60 is n, i.e., the lifting ratio of the Venetian blind is twice that of the aforesaid first embodiment of the present invention.

In the aforesaid second embodiment of the present invention, the ends of the lift cords 70 are fixedly fastened to the top end of the retractable tube 60 after extended over the pulley 68. Alternatively, the ends of the lift cords 70 can be fixedly fastened to the headrail 52 or, extended upwardly to the outside of the Venetian blind 50 and fixedly fastened to the ceiling or the wall of the building. Theoretically, fixedly fastening the ends of the lift cords 70 to a higher tube body, for example, the second tube body 64 of the retractable tube 60 achieves the aforesaid high speed ratio effect.

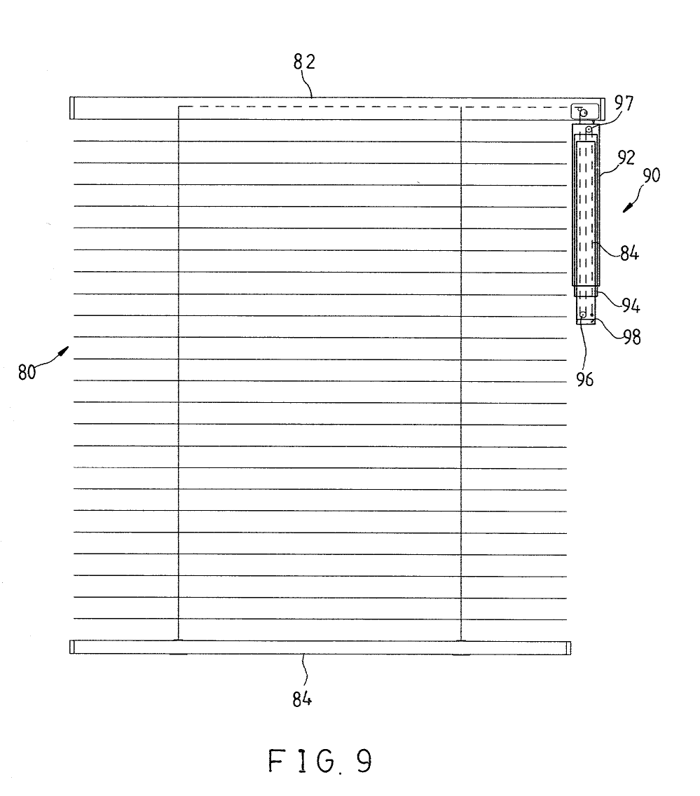

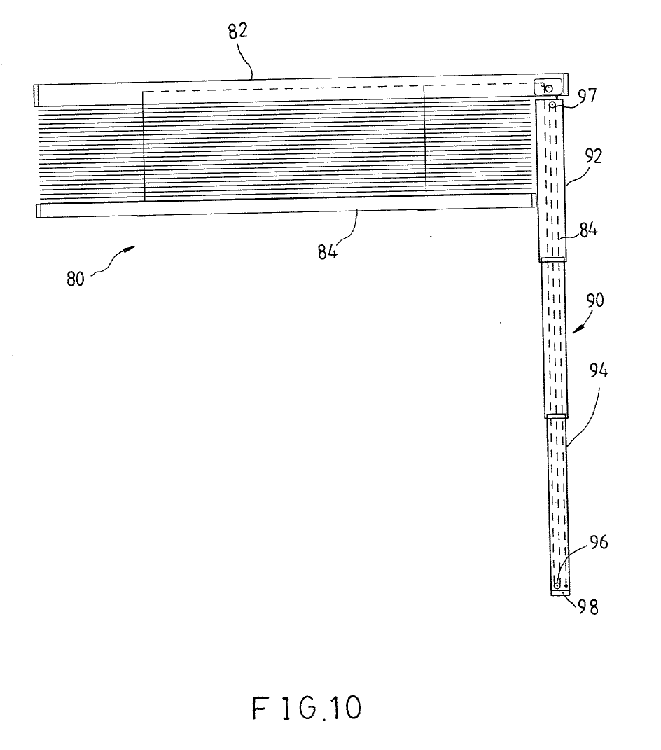

FIGS. 9 and 10 show a lift cord concealable Venetian blind 80 according to a third embodiment of the present invention. According to this embodiment, a first cord detour guide 96 is provided inside the last tube body 94 of the retractable tube 90 near its bottom end, and a second cord detour guide 97 is provided inside the first tube body 92 near its top end. After vertically downwardly inserted into the retractable tube 90, the lift cords 84 are extended over the first cord detour guide 96 and turned upwards, and then extended over the second cord detour guide 97 and turned downwards, and at final the ends of the lift cords 84 are fixedly fastened to the inside of the last tube body 94 near its bottom end. This arrangement greatly improves the speed ratio of the operation of lifting the bottom rail 84. Although this design greatly accelerates the bottom rail lifting speed, the user must employ much effort to pull the retractable tube 90. In order to save labor, a weight 98 is provided at the bottom end of the last tube body 94 of the retractable tube 90. The weight 98 enhances the downward pressure to the last tube body 94 of the retractable tube 90. Alternatively, the bottom end of the last tube body can be provided with mounting means (for example, a screw hole) for the positioning of a detachable counterweight. The Venetian blind manufacturer can provide counterweights of different weights for choice.

What the invention claimed is:

1. A lift cord concealable Venetian blind comprising:
a headrail extended in transverse direction, said headrail having a first end;
a bottom rail extended in transverse direction and spaced below said headrail;
a plurality of slats arranged in parallel between said headrail and said bottom rail;
at least one lift cord, said at least one lift cord each having a first end fixedly fastened to said bottom rail and a second end upwardly extended through a respective through hole in each of said slats into the inside of said headrail and then transversely extended to the first end of said headrail and then extended vertically downwards from the first end of said headrail; and
a retractable tube fastened to the second end of each of said at least one lift cord, said retractable tube comprising at least two tube bodies that slide one inside another, said at least two tube bodies having a first tube body connected at a top end thereof to the first end of the headrail and a last tube body such that the second end of each of said at least one lift cord is respectively downwardly extended out of the first end of said headrail and inserted into the inside of said retractable tube and coupled to said last tube body of said retractable tube for moving with said last tube body of said retractable tube to control the elevation of said bottom rail.

2. The lift cord concealable Venetian blind as claimed in claim 1 further comprising a lift lock installed in the first end of said headrail and controlled to lock/unlock said at least one lift cord; and wherein said first tube body of said retractable tube has the top end pivoted to said headrail.

3. The lift cord concealable Venetian blind as claimed in claim 1, wherein said tube bodies of said retractable tube fit one inside another such that said tube bodies are positioned in position by means of the effect of friction resistance between each two adjacent tube bodies after being moved relative to one another.

4. The lift cord concealable Venetian blind as claimed in claim 1, wherein said at least one lift cord each has the respective first end fixedly fastened to said bottom rail and the respective second end fixedly fastened to said last tube body of said retractable tube near a bottom end of said last tube body.

5. The lift cord concealable Venetian blind as claimed in claim 1, wherein said last tube body of said retractable tube comprises a cord detour guide disposed near a bottom end thereof; the second end of each of said at least one lift cord is vertically downwardly extended out of the first end of said headrail into the inside of said retractable tube and then extended over said cord detour guide and turned upwards and then fixedly fastened to an object above the elevation of said last tube body of said retractable tube.

6. The lift cord concealable Venetian blind as claimed in claim 5, wherein the second end of each of said at least one lift cord is fixedly fastened to the inside of said first tube body of said retractable tube after extended over said cord detour guide.

7. The lift cord concealable Venetian blind as claimed in claim 5, wherein the second end of each of said at least one lift cord is fixedly fastened to the first end of said headrail after extended over said cord detour guide.

8. The lift cord concealable Venetian blind as claimed in claim 5, wherein the second end of each of said at least one lift cord is extended upwardly out of said first tube body of said retractable tube and fixedly fastened to the ceiling of the room in which the lift cord concealable Venetian blind is installed after extended over said cord detour guide.

9. The lift cord concealable Venetian blind as claimed in claim 5, wherein said cord detour guide is a pulley pivoted to the inside of said last tube body of said retractable tube.

10. The lift cord concealable Venetian blind as claimed in claim 9, wherein said last tube body of said retractable tube comprises a smoothly arched guide spaced around the periphery of said cord detour guide and adapted for keeping said at least one lift cord extended over said cord detour guide.

11. The lift cord concealable Venetian blind as claimed in claim 1, wherein said retractable tube comprises a first cord detour guide provided inside said last tube body near a bottom end of said last tube body, and a second cord detour guide provided inside said first tube body near a top end of said first tube body; the second end of each of said at least one lift cord is extended downwards from the first end of said headrail into the inside of said retractable tube, and then extended over said first cord detour guide and turned upwards, and then extended over said second cord detour guide and turned downwards toward a bottom end of said last tube body and then fixedly fastened to one of the tube bodies of said retractable tube below the elevation of said first tube body.

12. The lift cord concealable Venetian blind as claimed in claim 11, wherein said first cord detour guide and said second cord detour guide each are comprised of a pulley.

13. The lift cord concealable Venetian blind as claimed in claim 12, wherein said retractable tube further comprises a first arched guard provided inside said last tube body and spaced around the periphery of said first cord detour guide, and a second arched guard provided inside said first tube body and spaced around the periphery of said second cord detour guide.

14. The lift cord concealable Venetian blind as claimed in claim 1, wherein the last tube body of said retractable tube has a bottom end mounted with a weight.

15. The lift cord concealable Venetian blind as claimed in claim 1, wherein the last tube body of said retractable tube comprises mounting means for the mounting of at least one detachable weight.

16. The lift cord concealable Venetian blind as claimed in claim 1, wherein said tube bodies of said retractable tube each comprise a retaining hole; said first tube body comprises a retaining spring plate provided at the periphery thereof, said retaining spring plate having a protruded retaining portion adapted for engaging the retaining holes of said tube bodies.
